(19) United States
(12) Patent Application Publication
(10) Pub. No.: US 2004/0220768 A1
(43) Pub. Date: Nov. 4, 2004

(54) Method for signalling a time of departure and a mobile data processing device

(76) Inventor: Bernhard Klein, Regensburg (DE)

Correspondence Address: BAKER & BOTTS, 30 ROCKEFELLER PLAZA, NEW YORK, NY, 10112

(21) Appl. No.: 10/129,588

(22) PCT Filed: Aug. 31, 2001
(86) PCT No.: PCT/DE01/03339

(30) Foreign Application Priority Data
Sep. 7, 2000 (DE) 10044259.5

(51) Int. Cl. G04F 1/00

(52) U.S. Cl. 702/176

(57) ABSTRACT

A method for signaling a departure time comprising calculating a route between a departure point for a transport means and an arrival point and the required time for the journey. On the basis of a desired arrival time, a departure time for a user is established and is timely signaled to the user. The method can be carried out by a mobile data processing unit whereby appointment planner software can output not only the appointment which is to be observed but also the departure time to be followed in order to be on time for the appointment.

### FIELD OF THE INVENTION

The invention relates to a method for signaling a departure time, and to a mobile data processing unit which is able to signal a user regarding the departure time.

### BACKGROUND OF THE INVENTION

The 4th IST (Intelligent Transport Systems) world congress in Berlin saw the Internet-based journey planner “Verkehr & Service Online” (VSO) introduced to the public. VSO provides information relating to a desired journey route, the probable journey time, and the choice of suitable transport means. The mobile terminal used is a combination of a Personal Digital Assistant (PDA) and a mobile telephone. To plan a journey, a user calls up an Internet page. Based on the input of starting point and destination, the desired date of travel and the time, the system calculates the best route and the likely journey time. Since the system takes into account statistical traffic data, the user is also intended to be given recommendations regarding a change of the departure time on the basis of the calculated journey time, with the likely journey time being reduced as a result of the change. However, the system is not able to signal the user the departure time when a destination needs to be reached at a particular time.

The program Time Table Viewer by Hiroaki Sengoku for Palm PDAs allows any timetables to be included. For a selected train on a timetable, the time until the next departure is displayed. However, the user is given no information regarding when he needs to set-off from his current location in order to be at a particular point at a particular time.

Patent specification DE 44 29 121 C1 discloses a navigation system in which a mobile radio can be used to retrieve route network data, and traffic information from a central station. The navigation system can be incorporated at least in part in a mobile telephone, so that the data required can also be retrieved outside of a vehicle.

### SUMMARY OF THE INVENTION

It is an object of the present invention to provide a method for signaling a departure time, and a portable data processing terminal which is able to signal to a user when he should depart in order to be at a destination at a particular time.

According to the invention, the user needing to arrive at a destination at a specific time is advised as to the time he must start the planned journey using the transport means suitable for the journey. This entails remembering that the user needs a certain amount of time in order to reach the transport means from his location. This access time can be preset as a fixed value or can be calculated on an individual basis.

Preferably, traffic conditions are taken into account in order to move the departure time to an earlier or later time as appropriate. In addition, a new route can be proposed, possibly by changing the transport means.

A route is preferably proposed to the user taking into account suitable public transport means or private transport means. Automatic selection of the transport means can take into account the availability, the journey time and the timetables of public transport means. A comparison between the transport times for a public transport means and for a private transport means, in particular for a car, and including the respective costs, can be taken as a basis for proposing to the user the transport means which covers the route most economically or most quickly.

The originally envisaged transport means can be changed on the basis of the current traffic information.

The method can be carried out on a fixed computer (PC), a portable computer (notebook), or by a PDA (pocket computer). This allows appointment planner software to output not only an appointment which is to be kept but also the appropriate departure time in order for the user to be on time.

### BRIEF DESCRIPTION OF THE DRAWINGS

Other features, advantages and opportunities for application of the present invention are disclosed below in the context of exemplary embodiments, in which:

FIG. 1 shows a navigation unit having an interface to a PDA,

FIG. 2 shows a PDA; and

FIG. 3 shows a planned route.

### DETAILED DESCRIPTION OF THE INVENTION

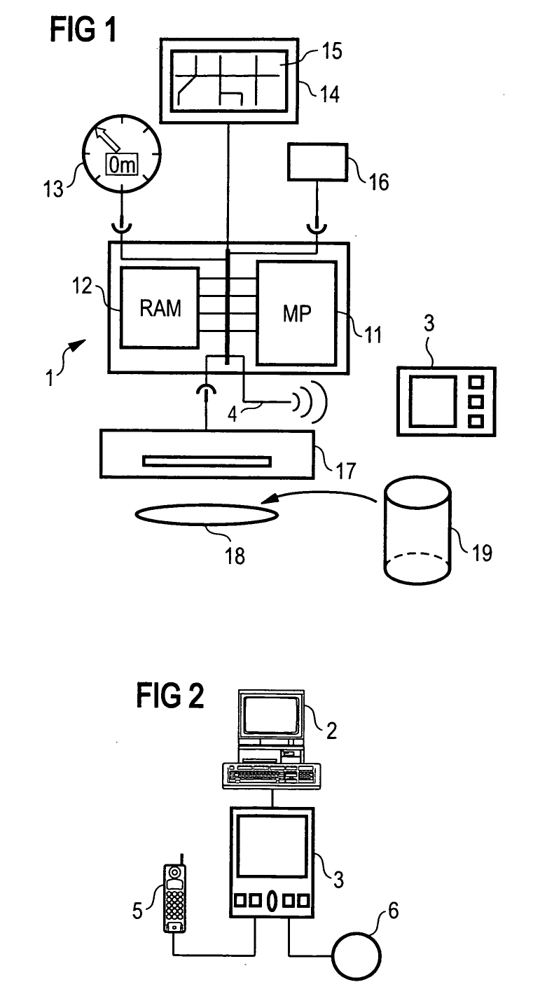

FIG. 1 shows a navigation unit 1 which is installed in a vehicle, for example, in a car, and has a processor 1 (microprocessor) and a memory 12. This memory is a main memory which can be overwritten. Further components are connected to the processor 1 by means of a bus system and include position sensors 13 comprising a distance sensor, a direction sensor and a GPS satellite receiver, a display device 14 which can show digital roadmaps 15 and calculated routes, a mobile telephone unit 16 which can be used to receive traffic announcements and to use them for route calculation, and a drive 17 for a storage medium 18, namely a DVD (digital versatile disk).

The storage medium 18 stores at least one database 19 comprising a network of road segments on the digital roadmap 15.

In addition, a mobile data processing unit 3, which is a PDA, can be connected to the navigation unit 1 via an interface 4. The interface is a wireless interface based on the Bluetooth standard. An extended radio link (mobile radio or cordless telephone) can alternatively be used to set up a direct connection between a home computer and the navigation unit.

The PDA can use the interface to input to the navigation unit 1 either a route already calculated in advance to a destination or just the destination. The navigation unit 1 accepts the previously calculated route or calculates a route itself in order to output guiding information to the user in this regard. It takes into account traffic information received via the mobile telephone unit 16, or via a broadcast radio receiver, and can propose an alternative route. The mobile telephone unit can be used to set up a connection to a service provider for Internet access or for traffic information. Both sources can be used to obtain current traffic information and traffic prognoses.

If the PDA is taken from the vehicle, this position is stored in the PDA. In this case, the position of the vehicle can either be transmitted to the PDA by the navigation unit, or the PDA can use a position sensor (for example satellite receiver) to take an independent position measurement. The signal for storing the vehicle position can be triggered either by removal from a fixing device in the vehicle or by isolation from the interface 4.

When not in the vehicle, the PDA can establish the distance to the vehicle after the new location has been input by the user or after automatic position finding, and can calculate a route from the user's current location back to the vehicle. This route can include a section on foot and possibly the use of public transport means. In addition, the PDA can calculate the time required to reach the vehicle from the current location.

FIG. 2 shows two interconnected data processing units. These are a fixed PC 2 (home computer), and a mobile data processing unit (PDA). The PDA is connected to a mobile telephone 5 and to a position sensor, namely a satellite receiver 6. These two components can also be incorporated into the PDA in the same way as a traffic radio receiver.

The user can use the computer 2 at home or at his workplace to determine a route to a destination. The route can be generated either using commercially available route calculation software on the computer 2 or by a host computer over the Internet. The route ascertained in this way can be transmitted to the PDA. In addition, the computer 2 can transmit parts of a digital roadmap to the PDA, so that the PDA is able to calculate a journey route autonomously.

By means of the connection to the mobile telephone 5, (or using an inbuilt mobile telephone unit or an inbuilt traffic radio receiver), the PDA can receive traffic information and use it for route calculation, and for calculating the timing of an alarm to signal a necessary departure time. The position sensor 6 allows the PDA to ascertain the current location of the user and the distance to the transport means which is to be used.

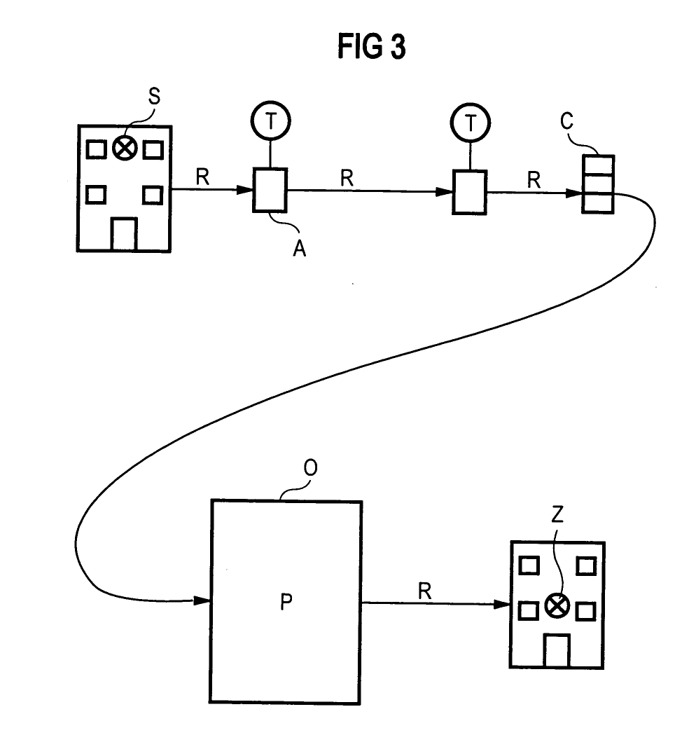

FIG. 3 shows a route R, calculated by a fixed computer, a PDA or a navigation unit, from a current location S for the user to a destination Z. The route R comprises a section on foot from the location S in a building to a departure point A, e.g., a stopping place for a public transport means T, such as an underground train, a train, a bus, a tram or the like. The route R also includes the distance to be covered by the public transport means T to the destination stopping place. After that, the route R leads via a section on foot to a private transport means C, e.g., the user's car. Alternatively, this stage of the route could lead to a rental car company where the user can rent a car to continue his journey.

Using the car, the route R continues to the arrival point O, for example, is a public car park. From there, the user needs to cover another section on foot to a building in which he has an appointment scheduled for a particular time.

To provide the user with a signal, signaling an appropriate departure time in order to be on time for his appointment, a data processing unit calculates the time which the user will require to reach the destination Z, and takes the time of the appointment at the destination Z and the total journey time as bases for calculating the departure time. The data processing unit outputs a visual and/or audible alarm at a particular interval of time before the departure time, which interval can be selected by the user.

The route and time planning is effected by calculating back from the destination Z to the current location S. First, the data processing unit calculates a pedestrian route starting from the destination Z to the planned arrival point O (car park). To calculate the period of time for the section on foot, a walking speed which is preset in the data processing unit's program, but which can be changed, is taken into account and is used to calculate a period of time for arriving at the destination.

Next, a route is ascertained for a car starting from the arrival point O to the stopping place for the public transport means T at which the user's car is located. The location of the vehicle can be input as an intermediate destination or can be stored in a portable data processing unit when leaving the vehicle. The stopping places for public transport means are regularly recorded as points of interest (POI) in the digital roadmaps for route calculation.

For the section of road from the arrival point O to the stopping place at which the car is parked, the likely journey time is ascertained on the basis of the flow of traffic which can be expected for the route on a statistical basis for the day of the week, and the time of travel. In this context, a period of time which can be influenced by the user is added as security in order to prevent the user from being tempted to drive too fast.

In addition, it is also necessary to take into account the length of time for walking/travelling between the stopping place for the public transport means and the vehicle's location including, if applicable the time it takes to rent a car.

If the likely journey time from the destination stopping place at which the car is located to the destination Z is known, the timetable for the public transport means T can be used to ascertain the means of transport which ensures arrival in good time at the stopping place at which the car is located.

The time at which the public transport means departs from the departure point A, which is known from the timetable stored in the data processing unit, also needs to have the length of time for walking from the user's current location S to the stopping place deducted from it in order to obtain the leaving time.

A route can take into account a plurality of appointments at various times at various locations which the user wishes to observe. If the user carries a mobile data processing unit with him, he will always receive a signal in good time for when he needs to set off in order to reach his next destination in good time.

The departure time from the location S, and possibly from intermediate destinations on the route, is entered into appointment planner software, so that the user can obtain an overview of the journey. Sufficiently prior to the departure time, the user receives a reminder from the fixed or mobile data processing unit to begin the journey.

1-14. Cancel

15. A method for providing a departure time signal comprising: calculating a route between a departure point for at least one transport means and an arrival point for the transport means;
calculating a journey time for the transport means to reach the arrival point;
taking into account an access time required between a starting location and the departure point;
determining a departure time by deducting the journey time and the access time from a desired arrival time at the arrival point;
recording the departure in a data processing unit; and
signaling the departure time.

16. The method according to claim 15, further comprising calculating a distance between the starting location and the departure point, and ascertaining the access time based on the distance.

17. The method according to claim 15, wherein the departure time is determined on the basis of the distance from the arrival point for the transport means to a selected destination.

18. The method according to claim 15, wherein the route takes into account a timetable for a public transport means and compares the time required for the public transport means with a time required for a private transport means, and identifies the transport means which covers the route most economically or most quickly.

19. The method according to claim 18, wherein the public transport means and private transport means are selected for parts of the route on the basis of their respective availability.

20. The method according to claim 15, further comprising storing in a mobile data processing unit the transport means' position when said unit is removed therefrom and the current location of a user.

21. The method according to claim 19, further comprising calculating by means of the mobile data processing unit a route from the user's location to the location of the user's transport means, and outputting said route to the user.

22. The method according to claim 15, further comprising taking into account traffic information in determining the departure time.

23. The method according to claim 15, further comprising taking into account traffic information in determining the transport means.

24. The method according to claim 15, further comprising taking into account traffic prognosis for determining a journey time for said transport means.

25. The method according to claim 15, further comprising changing the departure time and/or the transport means on the basis of traffic information.

26. The method according to claim 15, further comprising calculating the route by a portable data processing unit using traffic information as a basis for calculating a new route from a user's current location to the arrival point.

27. A portable data processing unit comprising:
a memory having a digital roadmap loaded therein,
a processor which (a) calculates a route from a first location to a second location; and (b) calculates an arrival time to the second location, and ascertains and signals a departure time required in order to meet the arrival time which takes into account means of transport and route conditions.
